(19) United States
(12) Patent Application Publication
(10) Pub. No.: US 2024/0061970 A1
(43) Pub. Date: Feb. 22, 2024

(54) METHOD AND NUMERICAL THREE-DIMENSIONAL MODEL TO SIMULATE DAM BREACH FOR HOMOGENEOUS AND ZONED SOIL DAMS

(71) Applicant: Zhengang Wang, Herndon, VA (US)

(72) Inventor: Zhengang Wang, Herndon, VA (US)

(21) Appl. No.: 17/820,630

(22) Filed: Aug. 18, 2022

(51) Int. Cl. G06F 30/20

(52) U.S. Cl. CPC G06F 30/20; G06F 2111/10

(57) ABSTRACT

Disclosed are method and a numerical three-dimensional dam breach model that calculate the dam break hydrograph for a homogeneous or zoned soil dam along with the visualized three-dimensional dam-breaching process and removed soil graph, wherein the failure mode can be overtopping failure, wind-generated wave overtopping failure, piping failure, or static liquefaction failure; wherein the dam can be breached at one location or multiple locations; and wherein elevations of the dam's crests and bottoms and soil properties at all stations along the dam's centerline are modeled. The topographic information surrounding the dam is pulled out from USGS DEM as a domain of the outer two-dimensional Shallow Water Equations grids that controls the hydraulic boundary conditions. Clear water scouring to different soils with different construction compaction efforts are calculated using corresponding erosion formulae. Force/moment equilibrium of soil blocks is analyzed, and instable soil blocks are removed.

### US CLASS CURRENT

405/107

### CPC CURRENT

| TYPE | CPC | DATE |
|---|---|---|
| CPCI | E 02 B 7/06 | 2022 May |
| CPCI | Y 02 A 10/11 | 2022 May |

### ACKNOWLEDGMENT

The inventor appreciates Alessandro Falappa for making the CGLEnabledView (version 1.4) Microsoft Visual C++ code available to be downloaded at www.codeproject.com and granting users the right to use, copy, and modify it. With necessary revisions, the CGLEnabledView (version 1.4) Microsoft Visual C++ code is used to show the dam breaching process using OpenGL.

### BACKGROUND OF THE INVENTION

### Field

This invention relates to a numerical method for calculating the dam breach hydrograph for a homogeneous or zoned soil dam in overtopping, piping, and/or liquefaction failures, and a corresponding computer program/model executing on a computer running on Microsoft Windows.

### Background

The following abbreviations are herein defined and referred within the following description: American Association of State Highway and Transportation Officials (AASHTO), Agricultural Research Service (ARS), cubic foot per second (cfs), Digital Elevation Models (DEM), Figure (FIG.), foot (ft), Investigation of Extreme Flood Processes and Uncertainty (IMPACT), Kilopascal (kPa), National Weather Service (NWS), North American Vertical Datum of 1988 (NAVD88), one-dimensional (1D), pounds per square foot (psf), Shallow Water Equations (SWE), three-dimensional (3D), two-dimensional (2D), Universal Transverse Mercator (UTM), U.S. Army Corps of Engineers (USACE), and U.S. Geological Survey (USGS).

The “left” side and “right” side of a dam and its breach channel are defined with the observer viewing the dam by looking in the downstream direction.

The dam breach hydrograph has been studied for decades since 1970s. Dr. Danny L. Fread at U.S. National Weather Service (NWS) developed NWS DAMBRK (Fread 1984) and NWS FLDWAV (Fread and Lewis, 1998) models to calculate the dam break hydrograph using pre-determined breach parameters that have been widely used in dam safety engineering, and developed NWS BREACH (Fread 1988) to calculate the breach parameters and breach hydrograph using a physically based method. U.S. Agricultural Research Service (ARS) did lots of headcut study to cohesive embankments and developed WinDAM C software to model erosion in earthen embankments. To better understand breach formation process, five physical dam-break tests were performed in Norway in 2002 and 2003 through European Commission funded IMPACT (Investigation of Extreme Flood Processes and Uncertainty) project.

Funded by Utah State University, and under the supervision of his major professor Dr. David S. Bowles, Zhengang Wang (the inventor himself) developed a numerical three-dimensional overtopping dam breach model for homogeneous non-cohesive soil dam in his Ph.D. dissertation in 2005, which covered a much wider area than existing models at that time, but was only tested using IMPACT Test #2 that was a homogenous non-cohesive soil dam overtopping failure with test data published through IMPACT Workshops and Meetings by 2005. After the research work was published by Advances in Water Resources through three journal articles in 2006 (Wang and Bowels, 2006a-c), the test data of all IMPACT's five physical tests were revised in 2008 (Hassan and Morris, 2008). That research only studied the overtopping breach of non-cohesive soil dam, and it did not touch headcut migration which is a difficult topic in dam breach modeling. That model used NWS BREACH's method to breach the dam until the dam crest is vertically eroded by 2 feet (0.61 meter), thereby it bypassed the headcut migration problem.

Dr. Weiming Wu developed DL Breach model (Wu 2013), which used ARS's pre-determined method (Temple 1992) to simulate headcut migration in cohesive embankments' overtopping failure, and used a pre-determined temporal evolution of 1D overtopping breach process for overtopping failure of zoned soil dams. DL BREACH has been included in USACE's HEC-RAS model. Both WinDAM C and DL Breach use the pre-determined soil parameters (such as material-dependent coefficients of headcut migration and/or lateral widening, soil erodibility coefficient, etc.) in overtopping failure of a cohesive embankment/dam.

### BRIEF SUMMARY OF THE INVENTION

This method uses 3D cuboids extending vertically from a dam's bottom to its surface to remember soil properties, hydraulic characteristics, topo information before and after erosion and stability analyses, etc.; uses different erosion formulae to calculate erosion rates of different AASHTO Soil Groups under different construction compaction efforts; performs 3D slope stability analysis during the headcut migration stage along the main flow direction in the breach channel, before a dam is breached through to its bottom; performs 3D slope stability analysis during the lateral widening stage perpendicular to the main flow direction in the breach channel, after a dam has been breached through to its bottom; and checks local force equilibrium in the entire dam-breaching process. The topographic information surrounding the dam is pulled out from USGS DEM as a domain of the outer 2D Shallow Water Equations (SWE) that controls the hydraulic boundary conditions. Normal flow, orifice flow, 1D SWE, and inner 2D SWE are solved to simulate the dam break flow at different breaching stages.

### BRIEF DESCRIPTION OF DRAWINGS

In the following, this disclosure is described with reference to the appended Figures. However, the scope of the invention is not limited to the specific features illustrated and disclosed by the Figures, wherein

FIG. 1A shows a basic cuboid having one soil, named as Cuboid Type 1, which is used to model the homogeneous soil dam and the shell area of a zoned soil dam except the upstream and downstream toes.

FIG. 1B shows a basic cuboid having two soils, named as Cuboid Type 2, with one soil on top and another soil on bottom, which is used to model the core area of a zoned soil dam.

FIG. 1C shows a basic cuboid having one soil located at the upstream toe of a dam, named as Cuboid Type 3.

FIG. 1D shows a basic cuboid having one soil located at the downstream toe of a dam, named as Cuboid Type 4.

FIG. 2A shows Cuboid Type 1 with lateral erosion, named as Erosion Type 1, located at the left side of a breach channel.

FIG. 2B shows Cuboid Type 1 with lateral erosion, named as Erosion Type 1, located at the right side of a breach channel.

FIG. 2C shows Cuboid Type 2 with lateral erosion, named as Erosion Type 1, located at the left side of a breach channel.

FIG. 2D shows Cuboid Type 2 with lateral erosion, named as Erosion Type 1, located at the right side of a breach channel.

FIG. 2E shows Cuboid Type 3 with lateral erosion, named as Erosion Type 1, located at the left side of a breach channel.

FIG. 2F shows Cuboid Type 3 with lateral erosion, named as Erosion Type 1, located at the right side of a breach channel.

FIG. 2G shows Cuboid Type 4 with lateral erosion, named as Erosion Type 1, located at the left side of a breach channel.

FIG. 2H shows Cuboid Type 4 with lateral erosion, named as Erosion Type 1, located at the right side of a breach channel.

FIG. 3A shows Cuboid Type 1 with lateral erosion, named as Erosion Type 2, located at the left side of a breach channel.

FIG. 3B shows Cuboid Type 1 with lateral erosion, named as Erosion Type 2, located at the right side of a breach channel.

FIG. 3C shows Cuboid Type 2 with lateral erosion, named as Erosion Type 2, located at the left side of a breach channel.

FIG. 3D shows Cuboid Type 2 with lateral erosion, named as Erosion Type 2, located at the right side of a breach channel.

FIG. 4A shows Cuboid Type 2 with lateral erosion, named as Erosion Type 3, located at the left side of a breach channel.

FIG. 4B shows Cuboid Type 2 with lateral erosion, named as Erosion Type 3, located at the right side of a breach channel.

FIG. 4C shows Cuboid Type 2 with lateral erosion, named as Erosion Type 4, located at the left side of a breach channel.

FIG. 4D shows Cuboid Type 2 with lateral erosion, named as Erosion Type 4, located at the right side of a breach channel.

FIG. 4E shows Cuboid Type 2 with lateral erosion, named as Erosion Type 5, located at the left side of a breach channel.

FIG. 4F shows Cuboid Type 2 with lateral erosion, named as Erosion Type 5, located at the right side of a breach channel.

FIG. 5A shows Cuboid Type 1 with a circular piping path, located at the left side of a breach channel.

FIG. 5B shows Cuboid Type 1 with a circular piping path, located at the right side of a breach channel.

FIG. 5C shows Cuboid Type 1 with a rectangular piping path, located at the left side of a breach channel.

FIG. 5D shows Cuboid Type 1 with a rectangular piping path, located at the right side of a breach channel.

FIG. 6A shows Cuboid Type 2, Case 1, with a circular piping path, located at the left side of a breach channel.

FIG. 6B shows Cuboid Type 2, Case 1, with a circular piping path, located at the right side of a breach channel.

FIG. 6C shows Cuboid Type 2, Case 2, with a circular piping path, located at the left side of a breach channel.

FIG. 6D shows Cuboid Type 2, Case 2, with a circular piping path, located at the right side of a breach channel.

FIG. 7A shows Cuboid Type 2, Case 1, with a rectangular piping path, located at the left side of a breach channel.

FIG. 7B shows Cuboid Type 2, Case 1, with a rectangular piping path, located at the right side of a breach channel.

FIG. 7C shows Cuboid Type 2, Case 2, with a rectangular piping path, located at the left side of a breach channel.

FIG. 7D shows Cuboid Type 2, Case 2, with a rectangular piping path, located at the right side of a breach channel.

FIG. 8A shows default phreatic surface defined by lines A-B-C-D-E-F in zoned dams with a clay core.

FIG. 8B shows default phreatic surface defined by lines A-B-C-D-E-F in homogeneous dams, in which elevations of Points B, C, D, E, and F are calculated using the method of Phatak et al. (2004).

FIG. 9A shows a smaller DEM for Teton Dam, clipped from USGS DEM, converted to UTM in meters and shown by this model.

FIG. 9B shows the input dialog to rotate the clipped and converted DEM as shown in FIG. 9A.

FIG. 9C shows an example drawing in the input dialog to rotate the clipped and converted DEM as shown in FIG. 9A

FIG. 9D shows the input Excel file to rotate the clipped and converted DEM as shown in FIG. 9A, which is an alternative method to the input dialog as shown in FIG. 9B.

FIG. 9E shows the input MS Excel file to rotate the clipped and converted DEM as shown in FIG. 9A, with outputs written back to the same Excel file

FIG. 10A shows Teton Dam's reservoir found by this model and shown in dark color.

FIG. 10B shows Teton Dam's reservoir found by this model and enclosed by lines.

FIG. 10C shows the input file in text file format to find Teton Dam's reservoir by this model.

FIG. 10D shows the output file with the “stage-surface area” chart of Teton Dam's reservoir found by this model.

FIG. 11 shows the calculated Teton Dam failure in Idaho in 1976 when the peak outflow was released at the dam, modeled as a zoned soil dam, with DEM displayed.

FIG. 12A shows the calculated Teton Dam failure when the peak outflow was released at the dam, with flow velocities displayed.

FIG. 12B shows the calculated Teton Dam failure when the peak outflow was released at the dam, without flow velocities displayed.

FIG. 13 shows the calculated Teton Dam failure when the peak outflow was released at the dam, with clay core displayed.

FIG. 14 shows the calculated Teton Dam final failure shape.

FIG. 15 shows the calculated breach hydrograph and removed soil graph at Teton Dam.

FIG. 16A shows the calculated Laurel Run Dam failure in Pennsylvania in 1977 by the “leading headcut” at Location #2 (left, viewing downstream), modeled as a zoned soil dam, by using the maximum measured unconfined compressive strength of 953 psf (45.6 kPa) for clay core according to Gray (1992) at Location #1, and using the minimum measured unconfined compressive strength of 410 psf (19.6 kPa) for clay core according to Gray (1992) at Location #2.

FIG. 16B shows the calculated breach channel at Location #1 (right) for Laurel Run Dam failure, where the dam didn't breach because reservoir water level receded.

FIG. 16C shows the calculated breach channel at Location #2 (left) for Laurel Run Dam failure, where the dam was breached by the “leading headcut”.

FIG. 17A shows the liquefaction failure at Edenville Dam, Michigan, at 17:36 PM on May 19, 2020, modeled as a homogeneous non-cohesive soil dam.

FIG. 17B shows the breach shape at one hour after the liquefaction failure at Edenville Dam, View 1.

FIG. 17C shows the breach shape at one hour after the liquefaction failure at Edenville Dam, View 2.

FIG. 17D shows the breach shape at one hour after the liquefaction failure at Edenville Dam, View 3.

FIG. 18A shows the simulated failure of South Fork Dam in Pennsylvania in 1889, when the dam was breached through and the emergency spillway was still releasing flow, modeled as a homogeneous cohesive soil dam.

FIG. 18B shows that the instable slopes at two sides of the breach channel are removed in Stage 3 using South Fork Dam as an example. The 3D slope stability at two sides of the breach channel perpendicular to the main flow direction is checked in Stage 3 (lateral widening stage after the dam is breached to its bottom), and instable slopes are removed.

FIG. 18C shows the calculated final breach shape of South Fork Dam.

FIG. 19 shows Teton Dam, displayed with an angle of 30 degrees to the horizontal line on a computer's screen, which is given by the user in the input file.

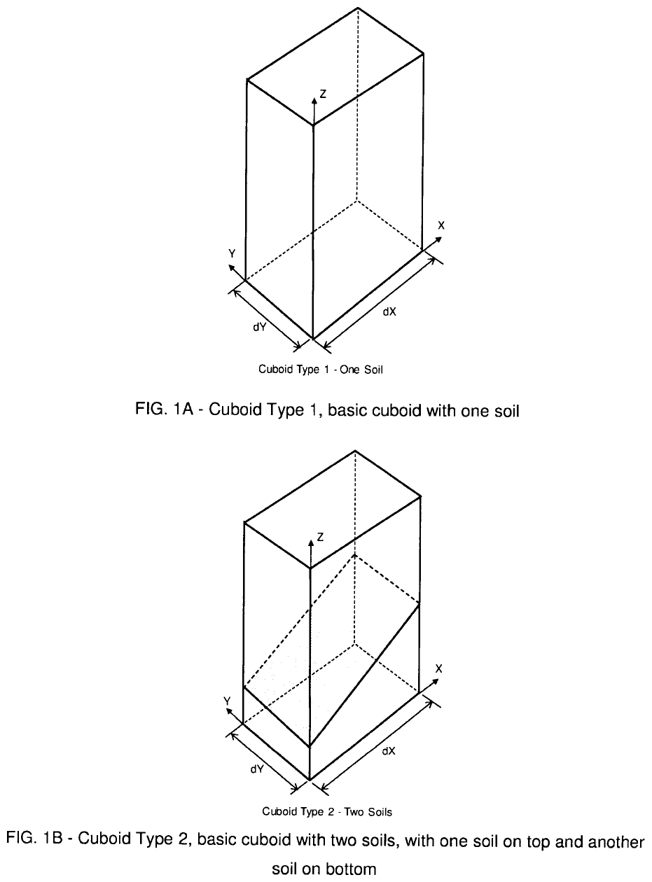

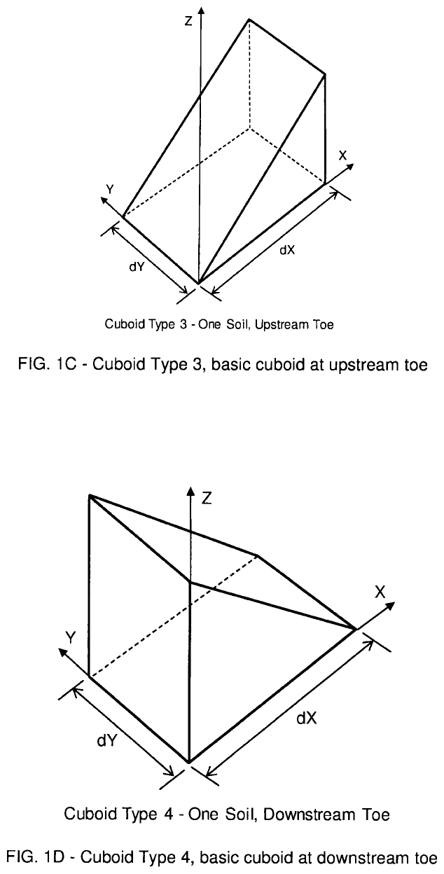

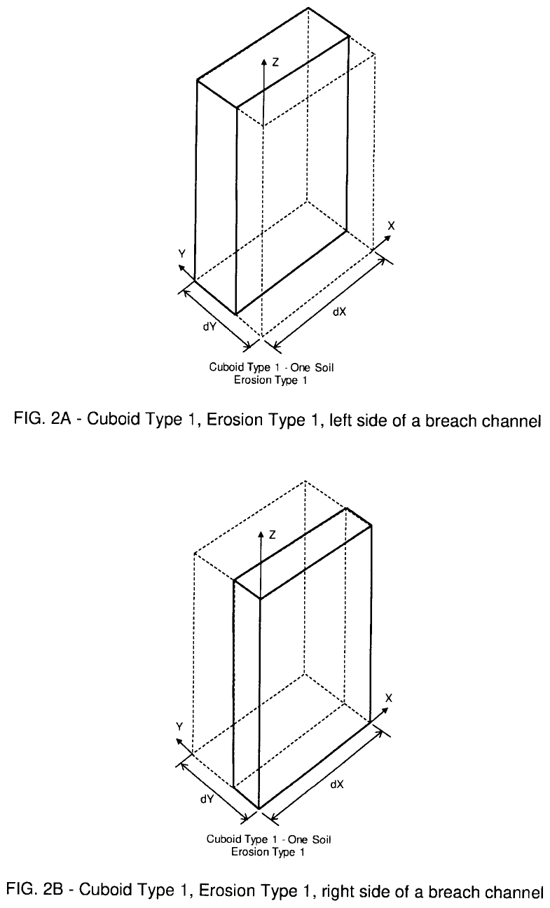

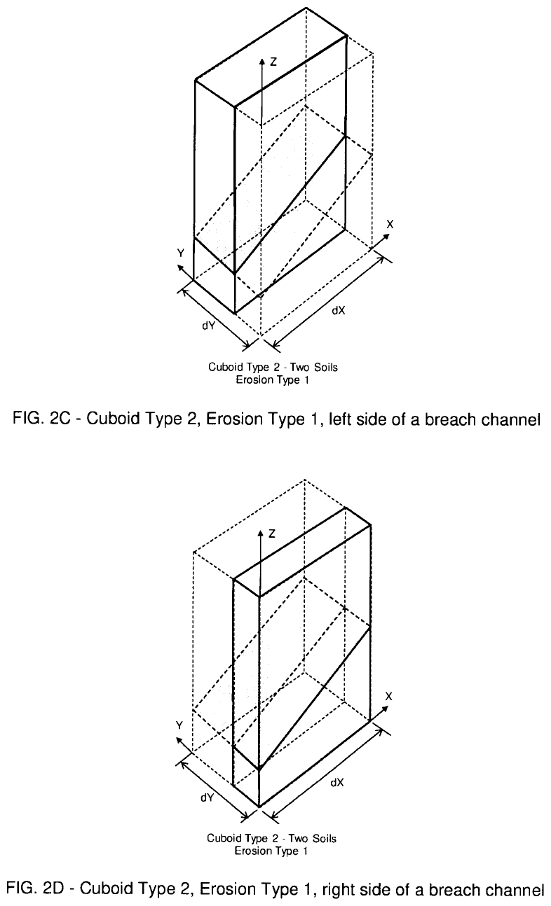

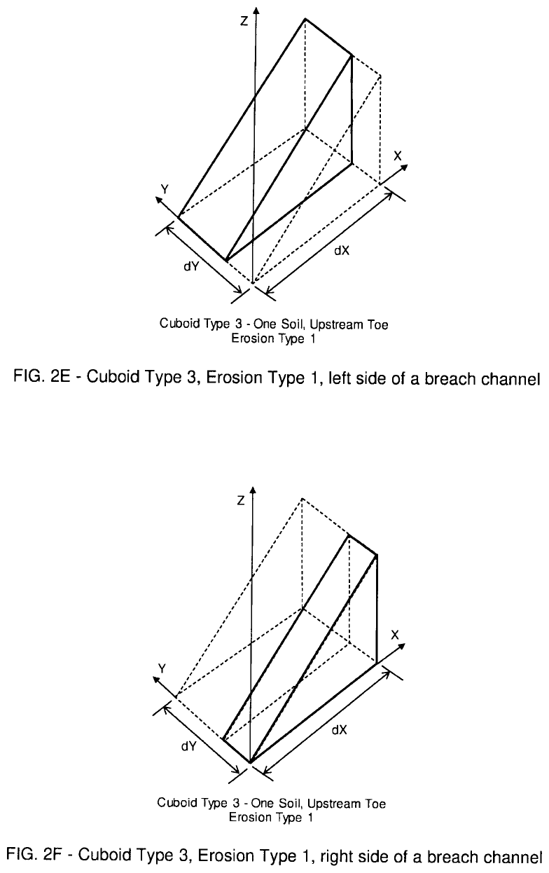

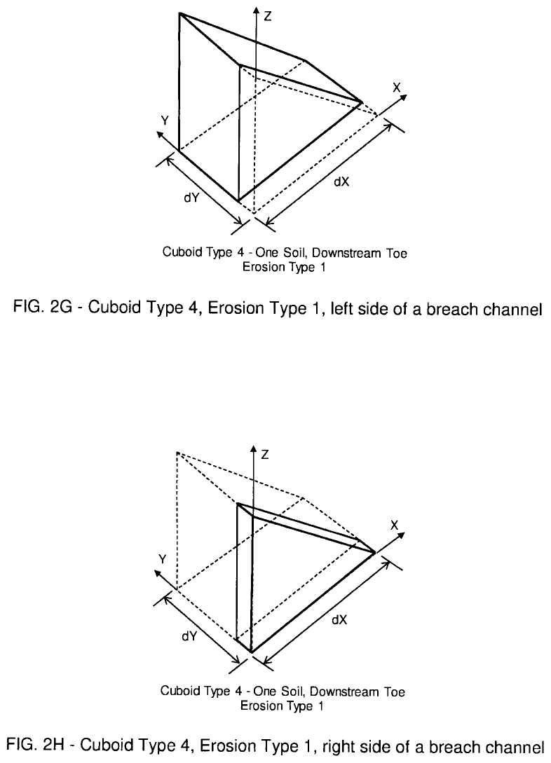

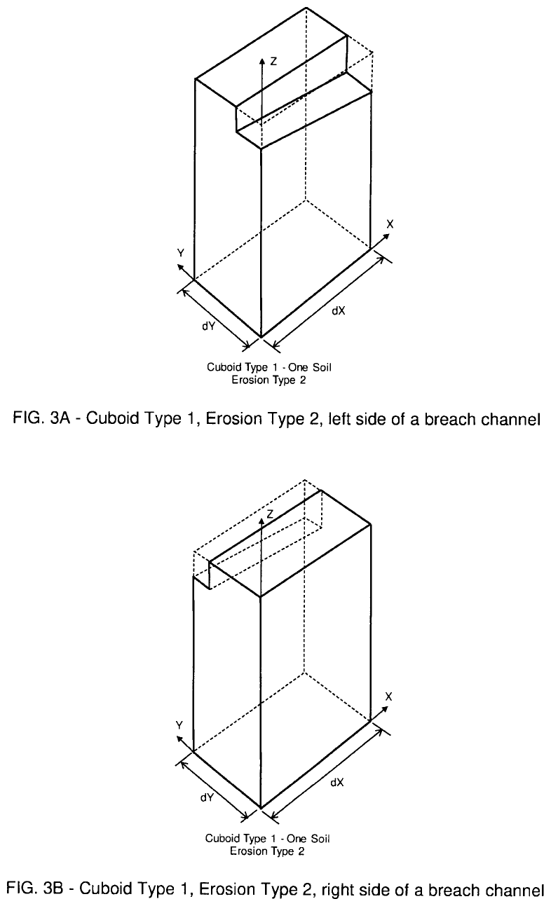

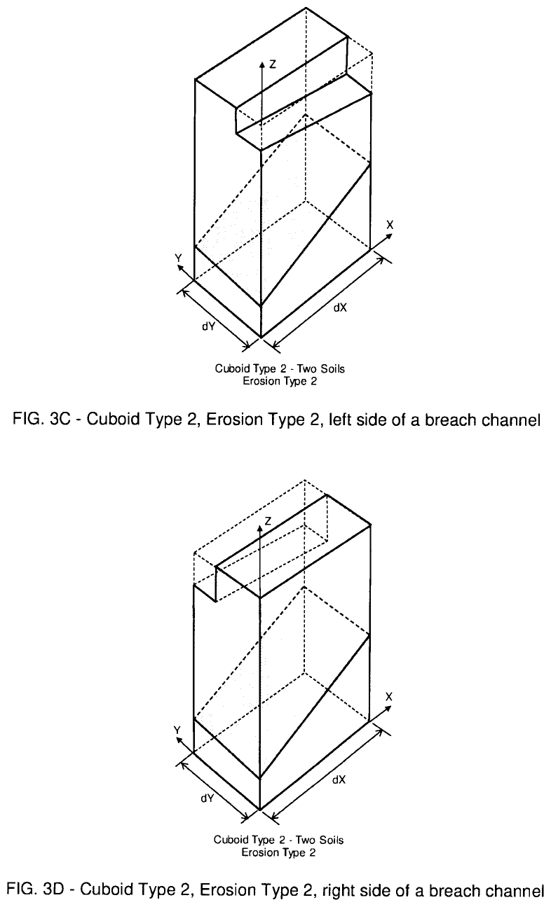

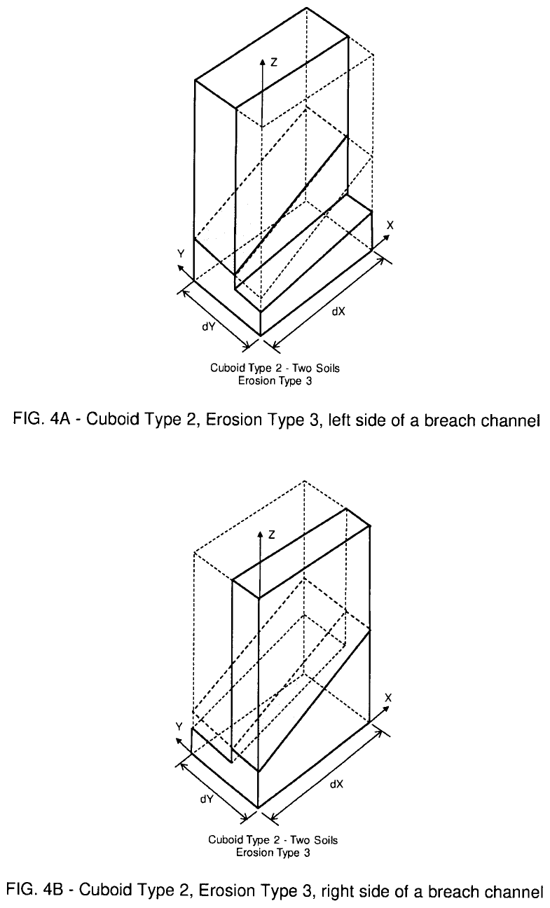

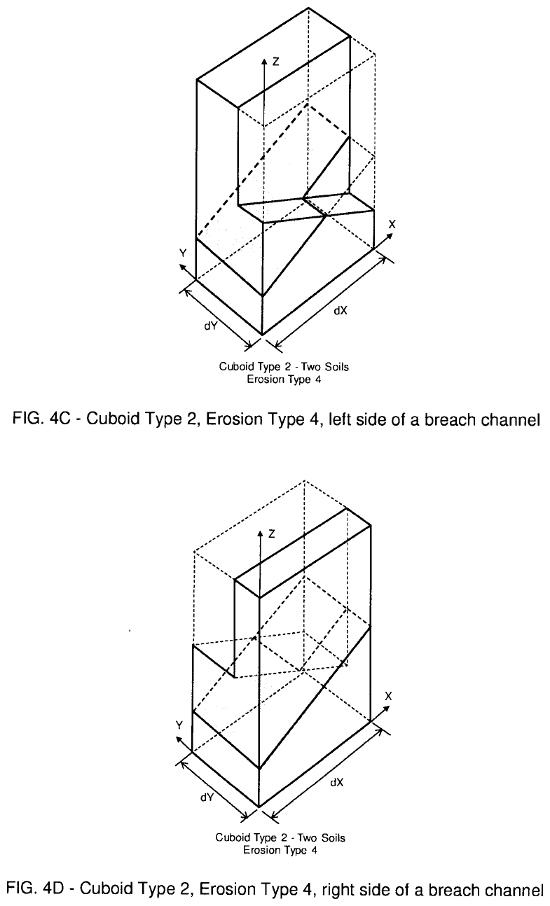

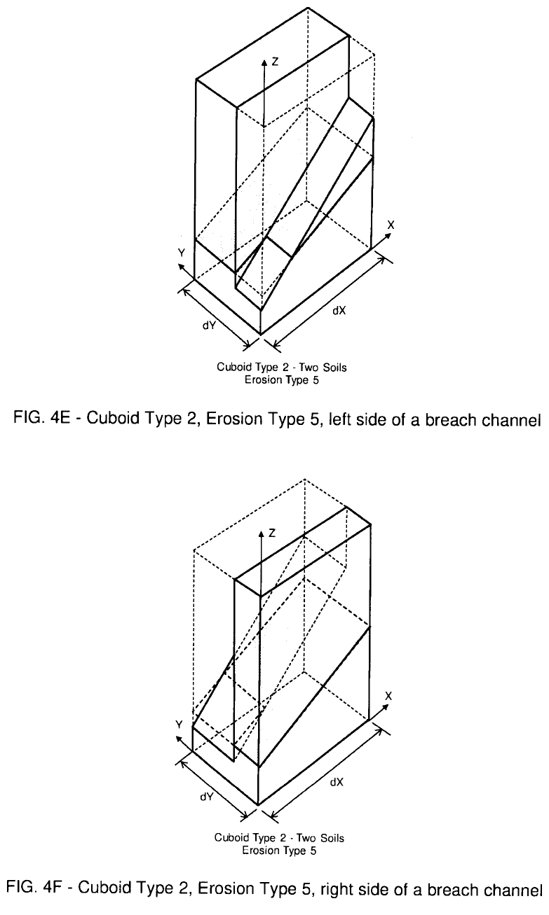

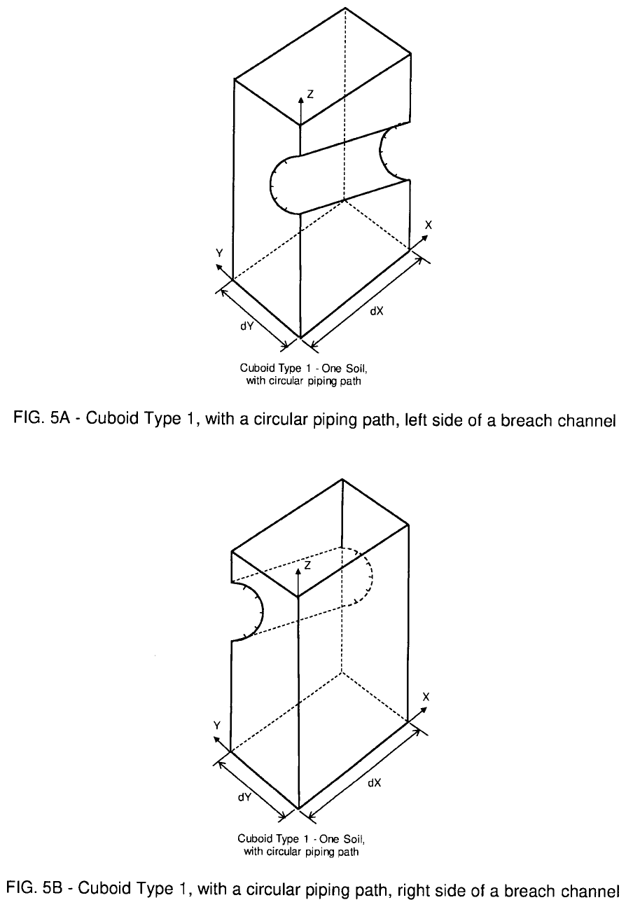

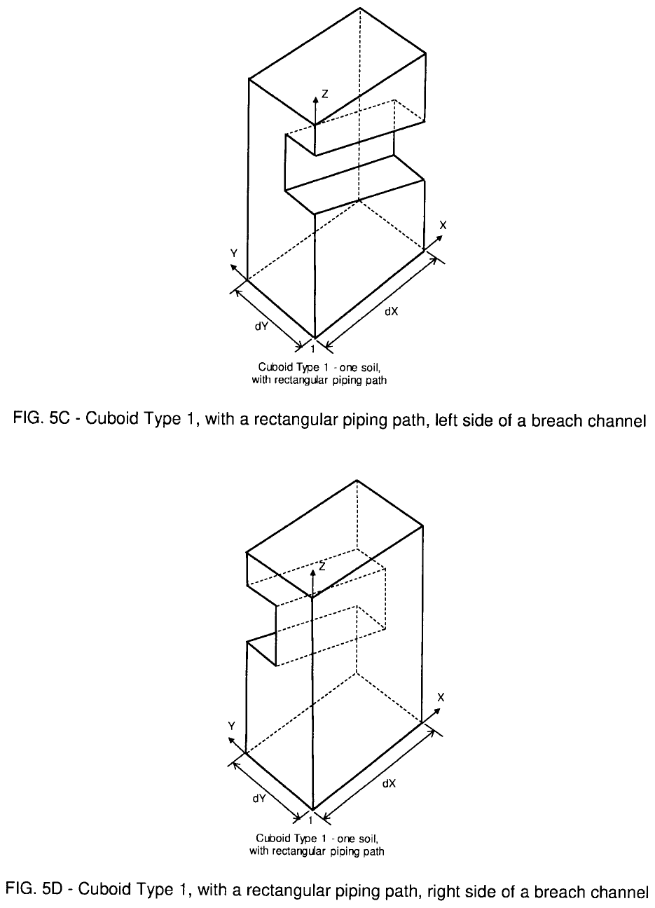

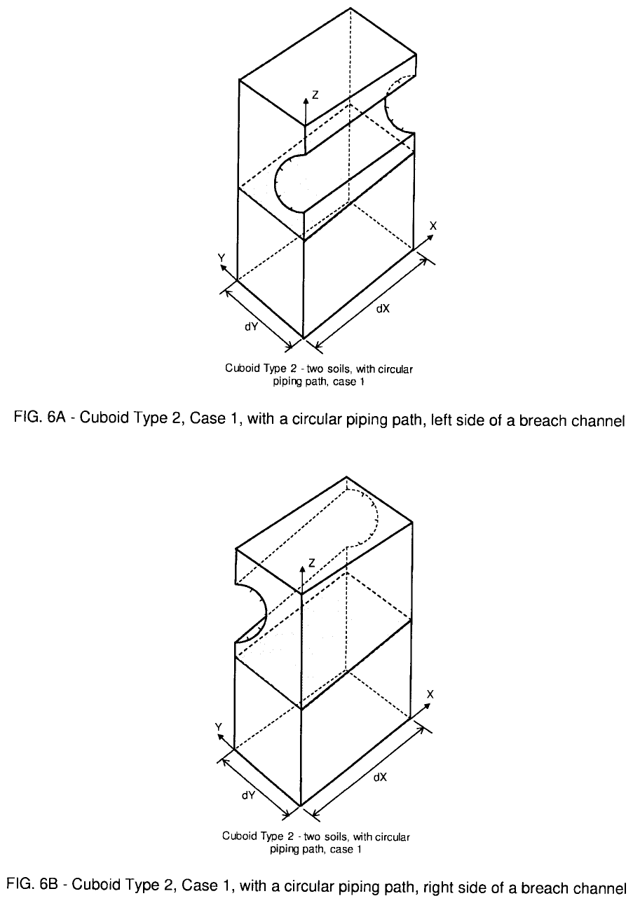

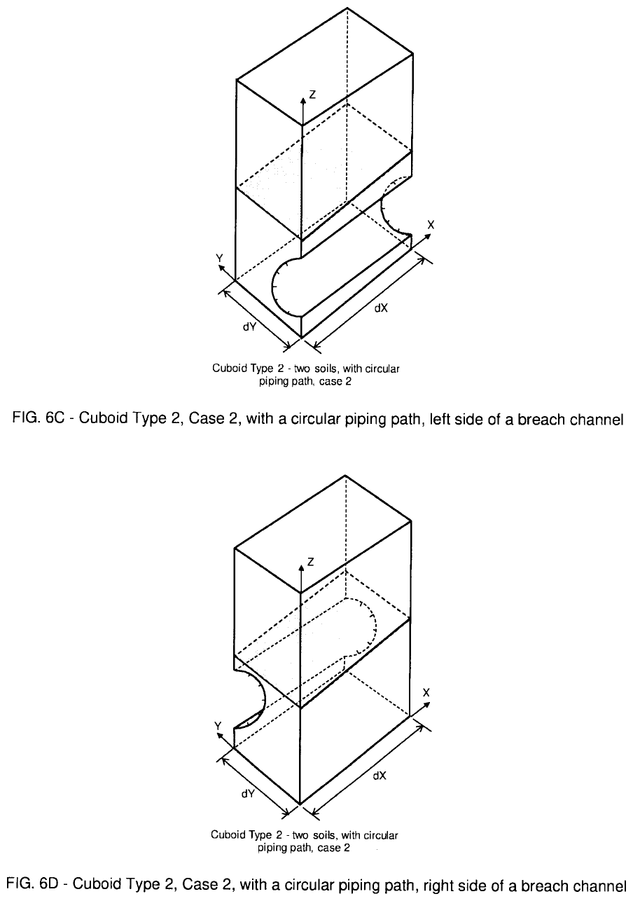

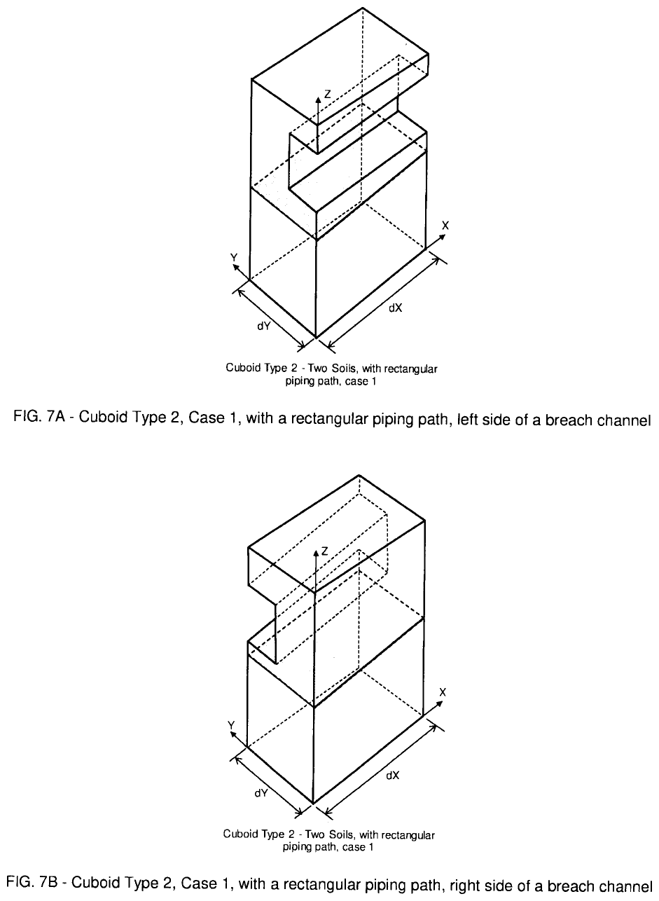

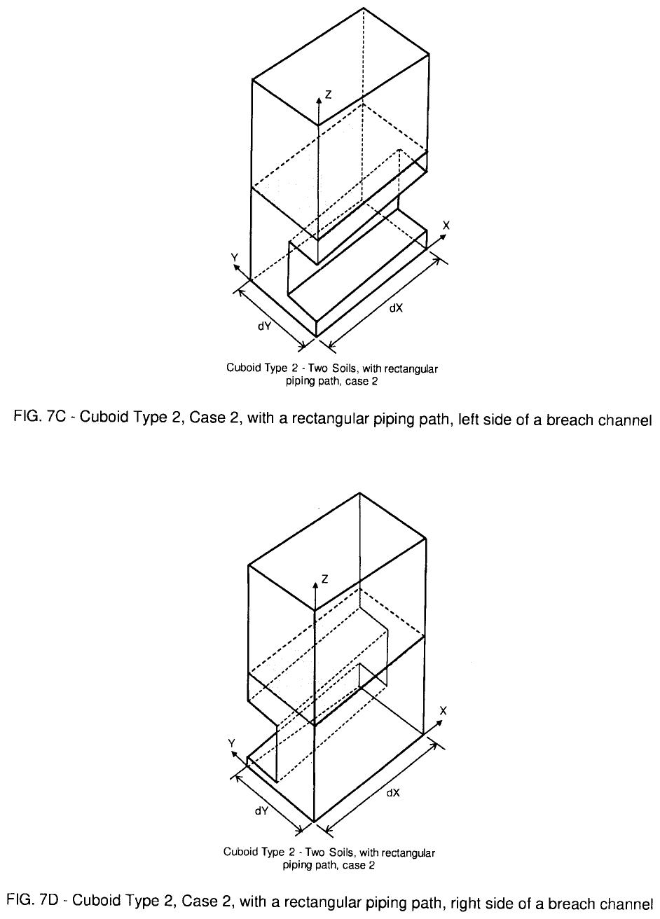

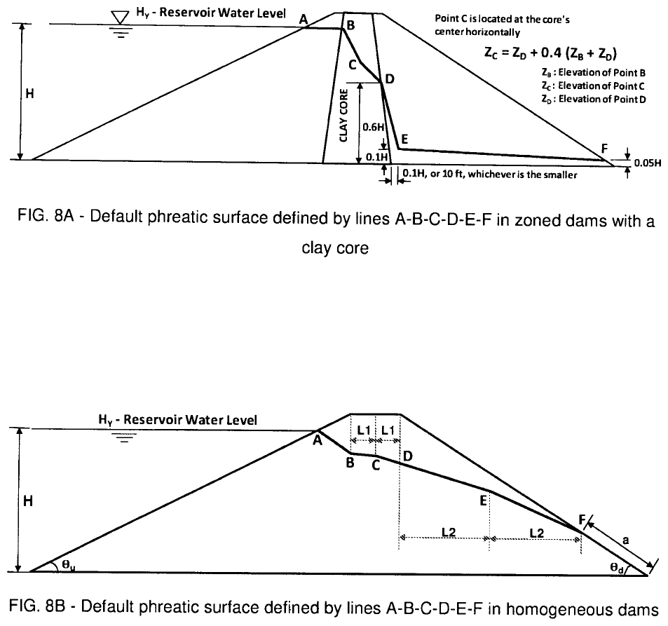

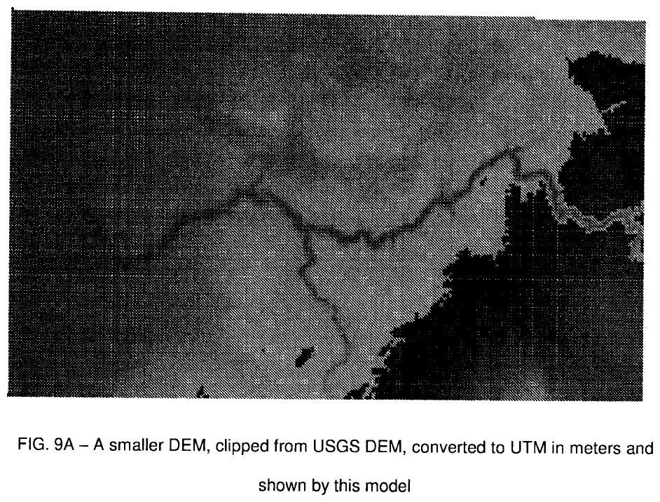

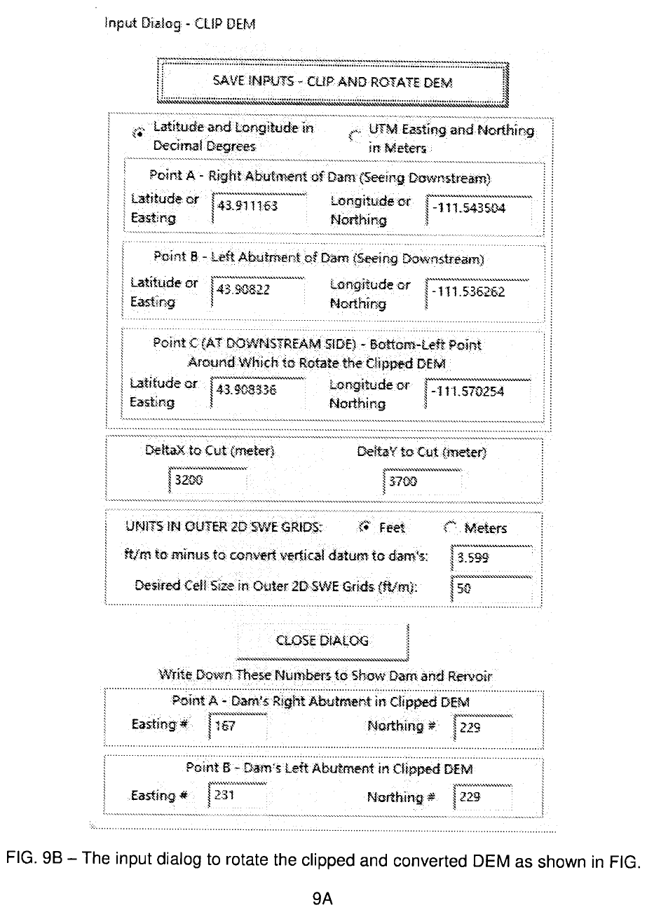

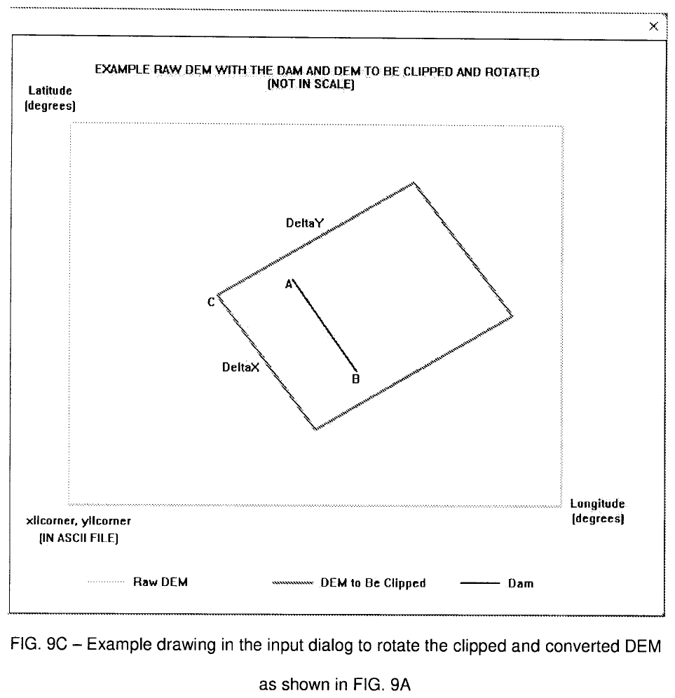

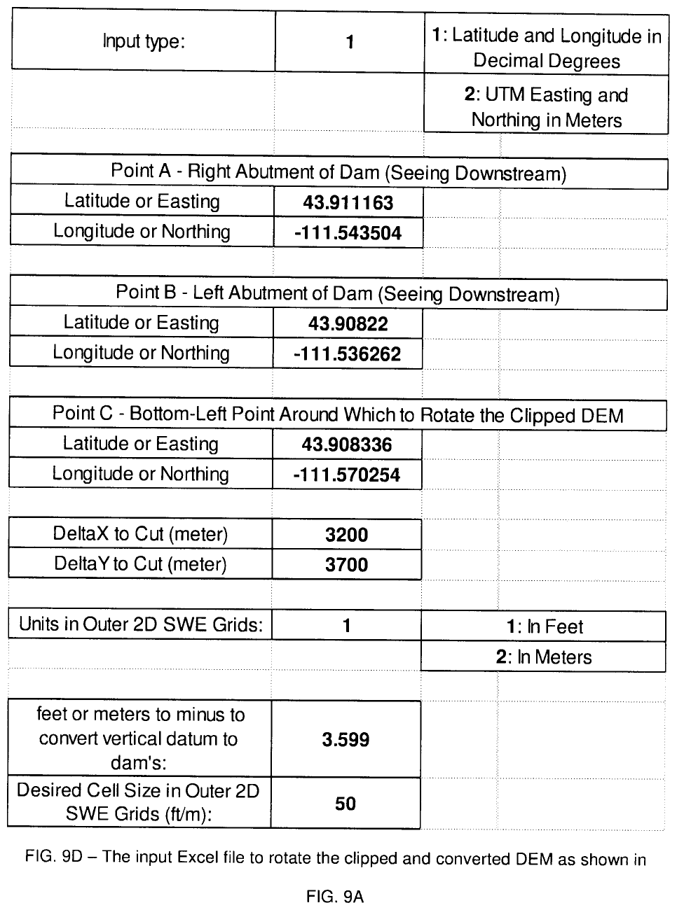

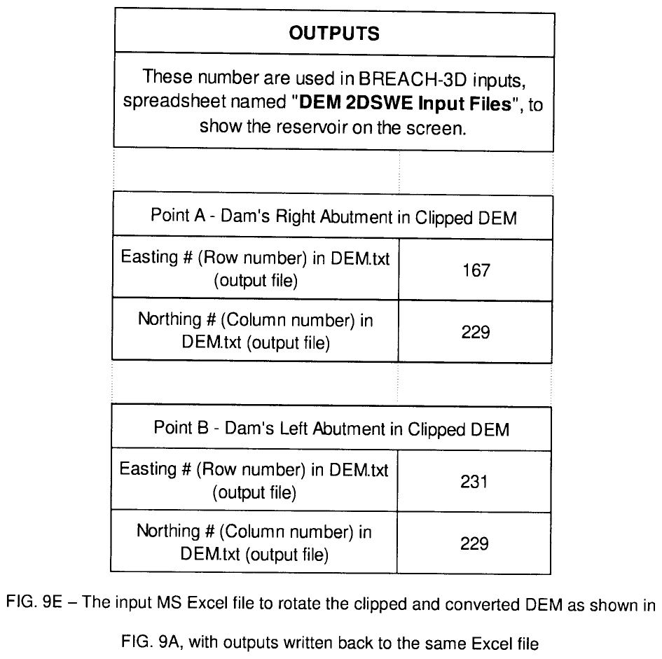

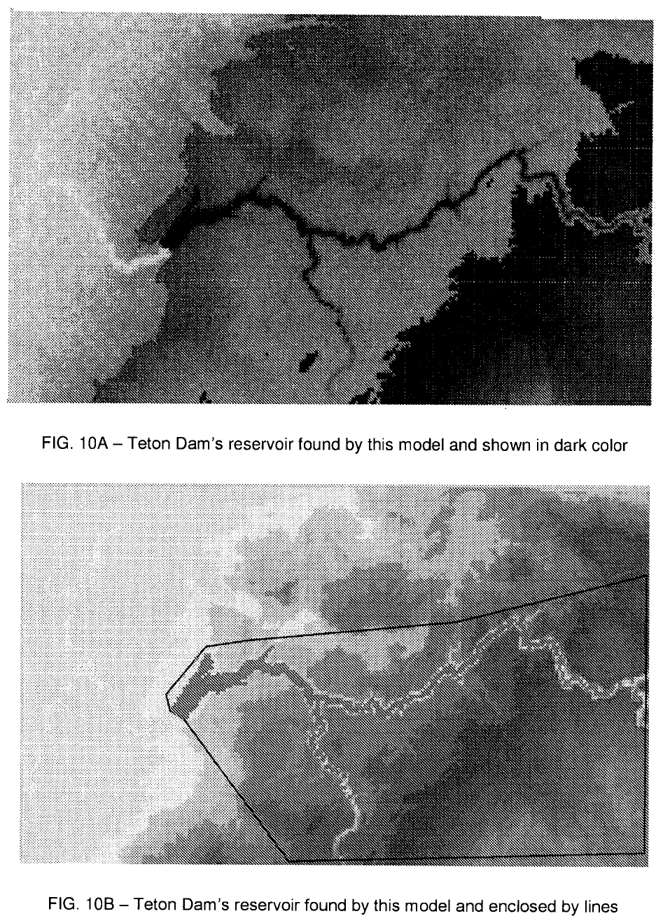

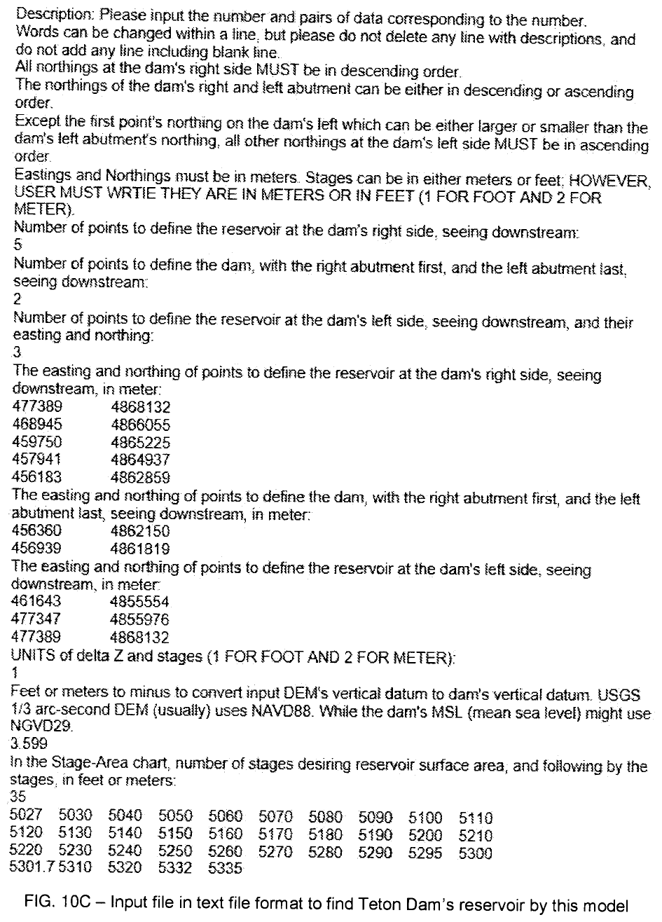

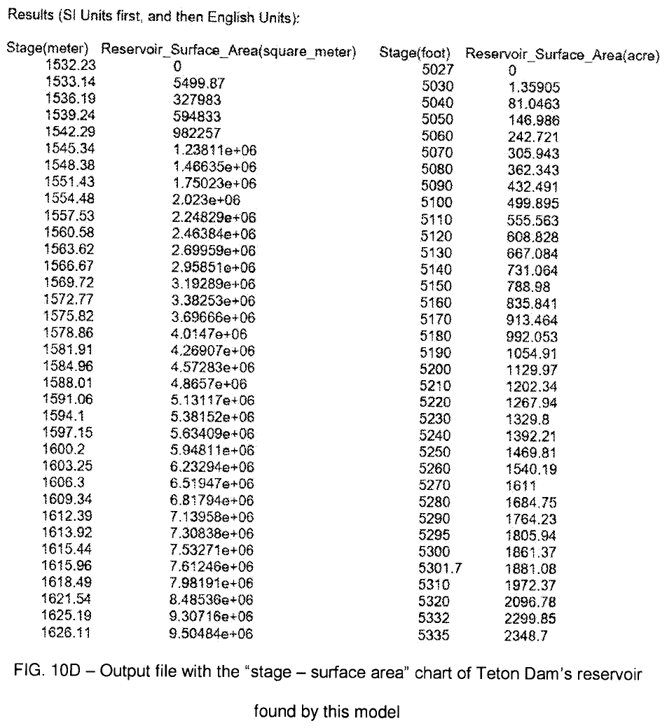

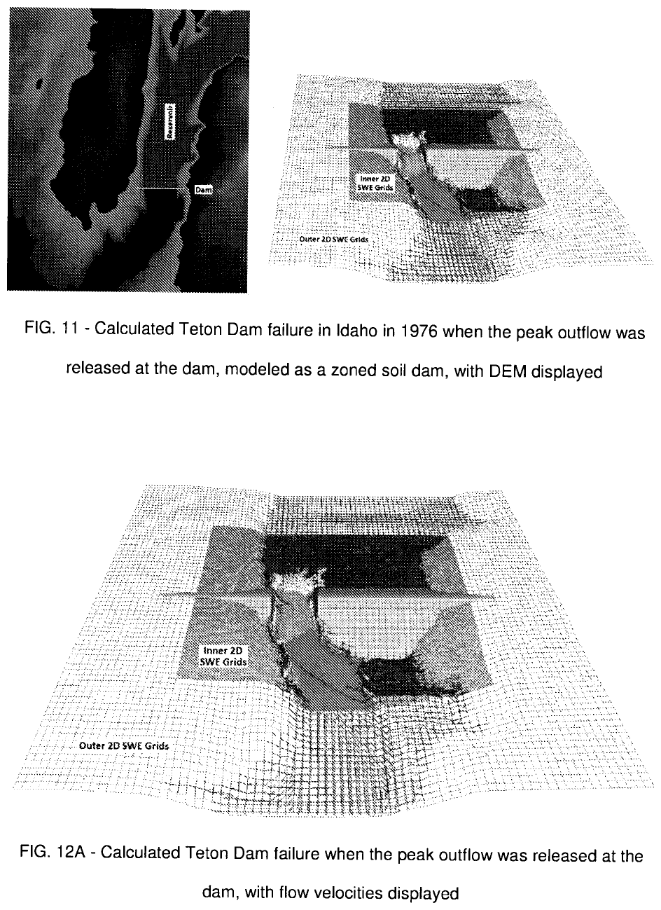

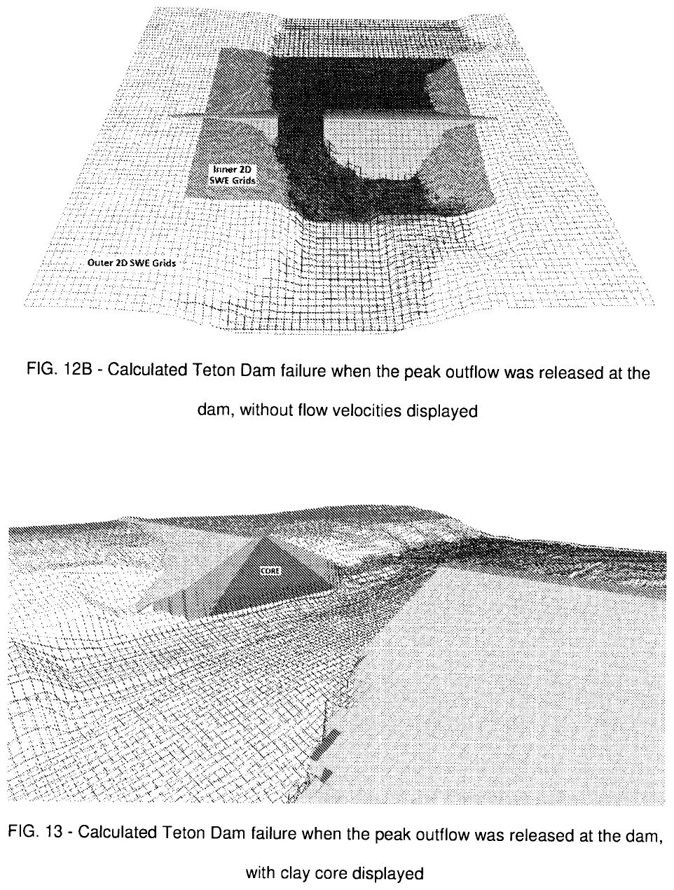

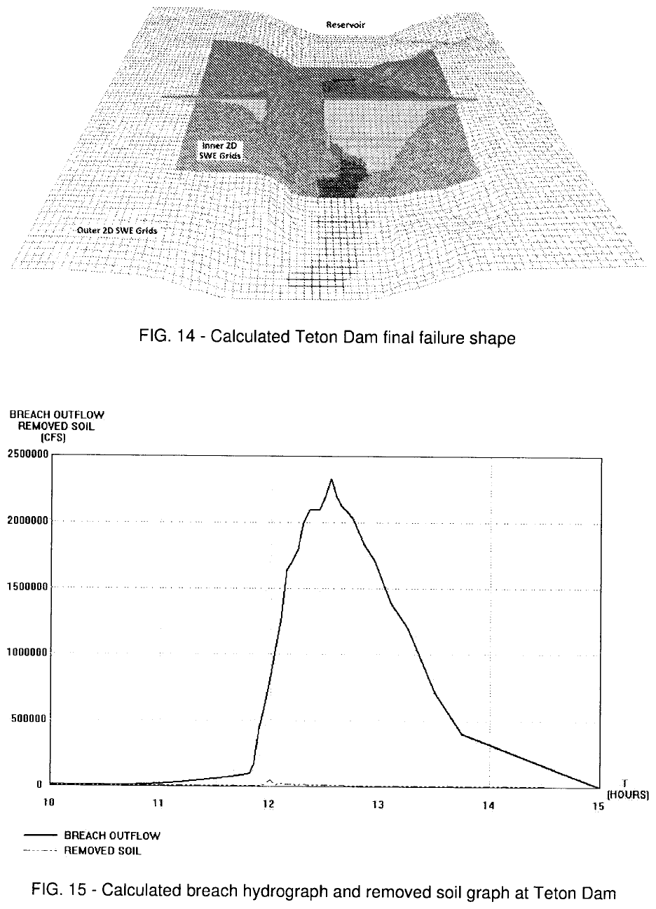

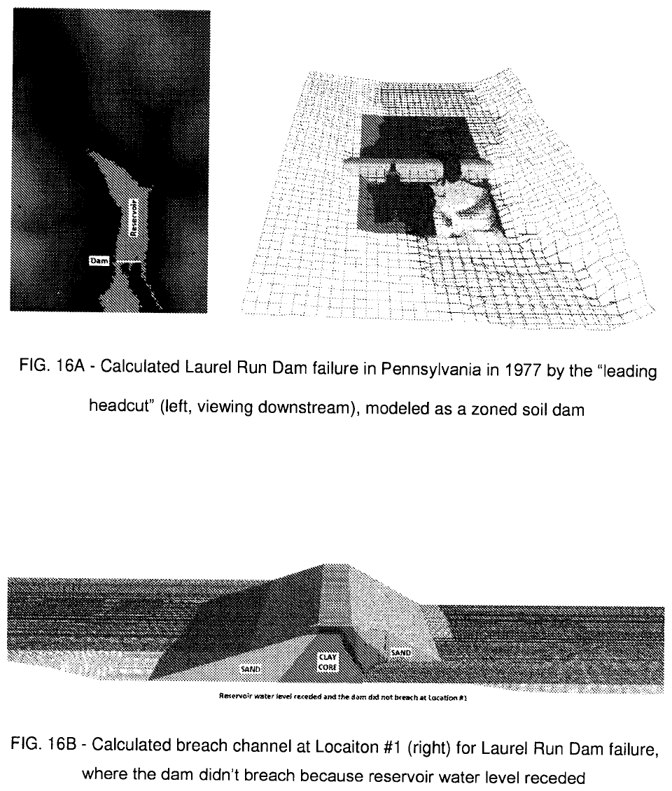

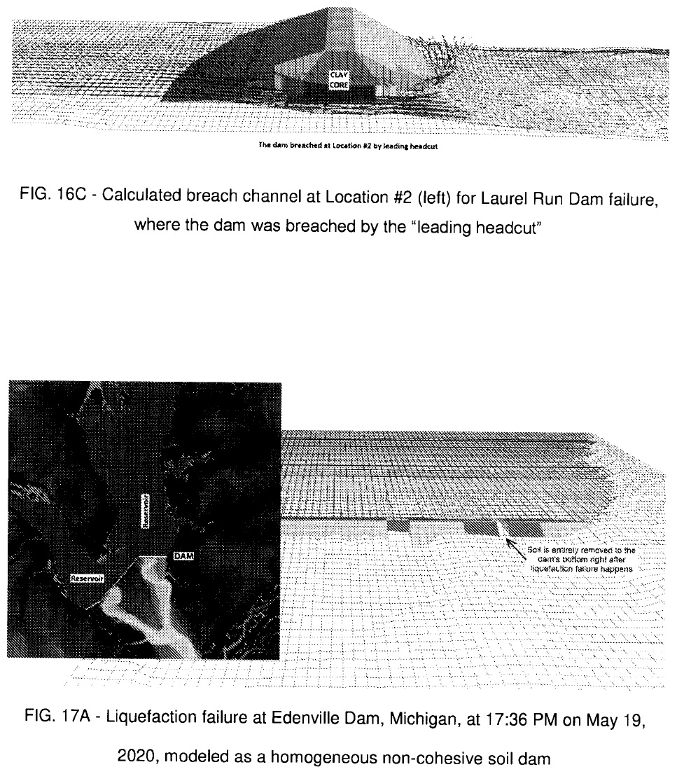

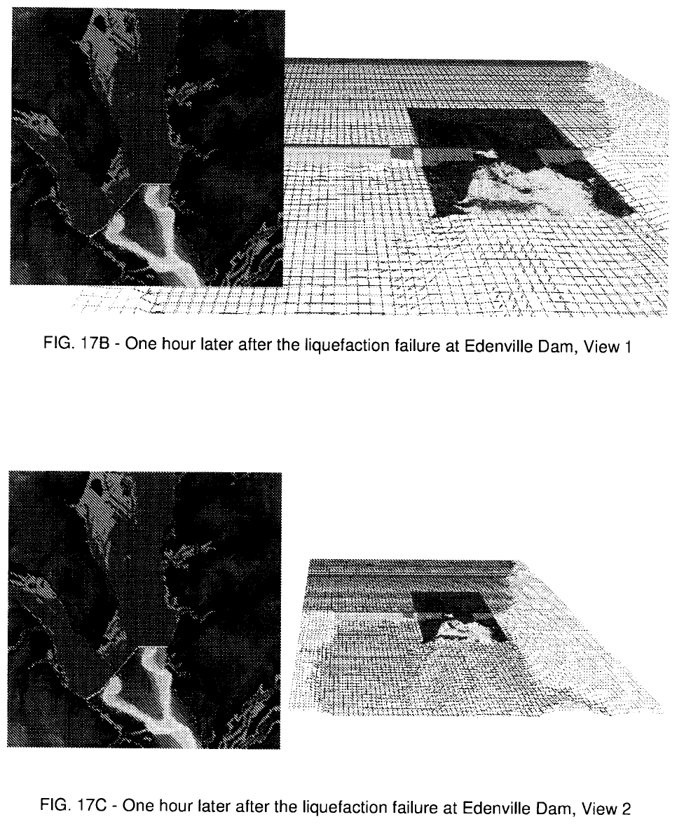

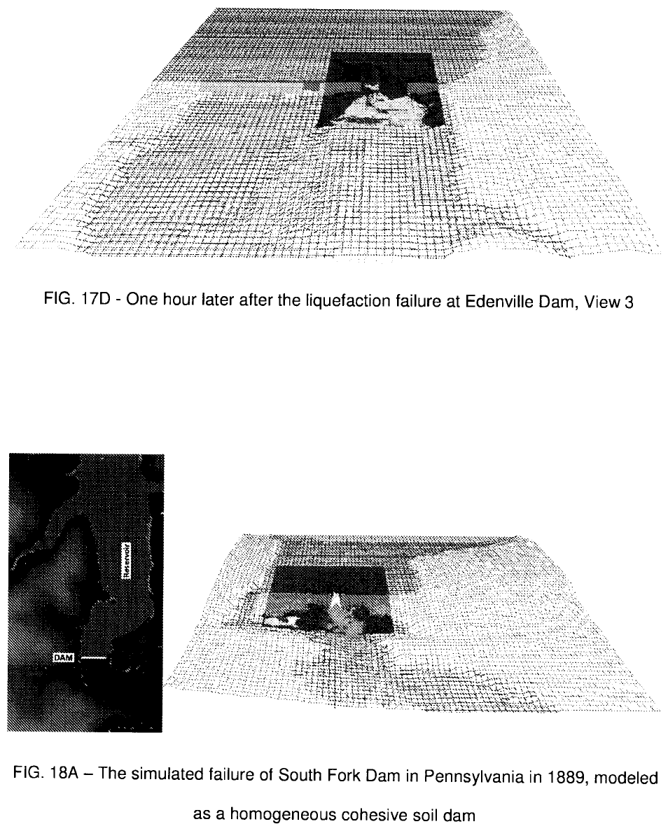

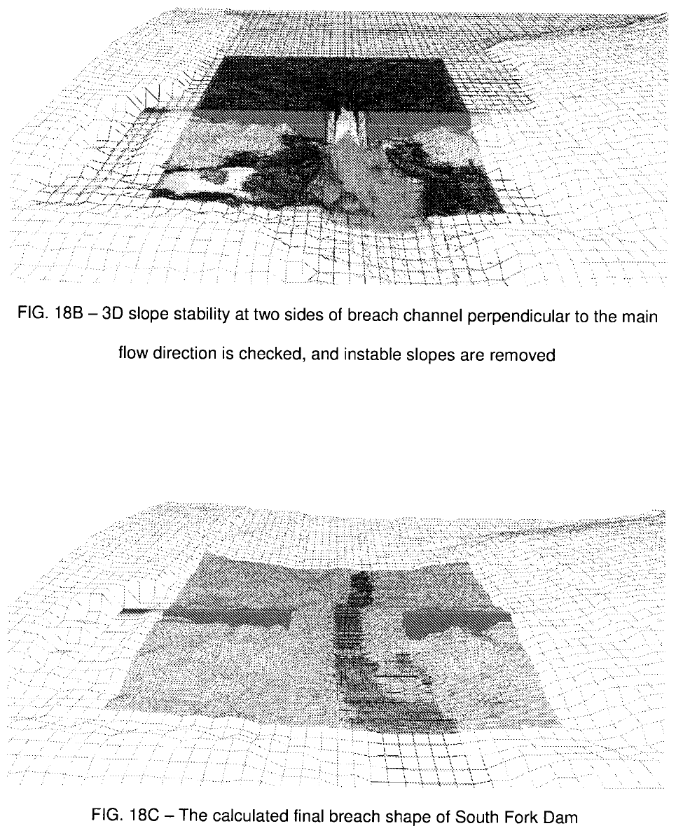

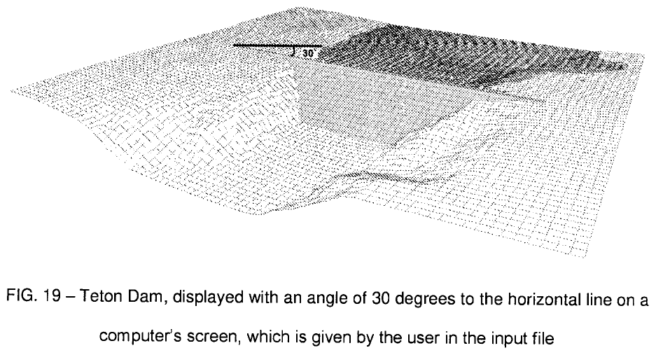

### DETAILED DESCRIPTION OF THE INVENTION

Input files of this model are prepared using a free software QGIS, this model itself, and Microsoft Excel. USGS DEM containing the dam and reservoir is downloaded firstly. Then the USGS DEM is clipped to an Esri ASCII file containing the dam and its reservoir using QGIS. This model along with its pre-processing functions can project the ASCII elevations in decimal degree coordinates (latitude/longitude) to Universal Transverse Mercator (UTM) corresponding zone in meters, and rotate it so that the dam's centerline is displayed horizontally on a computer screen and the reservoir is displayed on the top of the dam always. In this model, the dam can be displayed horizontally at a computer screen and its reservoir is shown at the dam's top, or the dam can be displayed with an angle between 0 and 360 degrees given by the user, by using 0 (or 360) degree when the dam is displayed horizontally at a computer screen and its reservoir is shown at the dam's top. This model's pre-processing functions can also calculate the reservoir's stage-area chart from the projected DEM, and adjust the elevation difference between the dam's vertical datum and USGS DEM's vertical datum (which is usually North American Vertical Datum of 1988, NAVD88).

This invention uses a large layer of outer 2D SWE grids, which can be pulled out from USGS DEM and corrected using real dam's data, and covers the entire dam and portion of the dam's upstream and downstream areas, to control the upstream inflow condition and downstream outflow condition. And it uses a smaller layer of inner 2D SWE grids automatically by this model to cover the dam's breached portion and the breach channel area. The outer 2D SWE grids and the inner 2D SWE grids exchange data at each time-step calculation, so that the inner 2D SWE grids' boundary conditions are controlled by the outer 2D SWE grids and the outer 2D SWE grids' data inside of the inner 2D SWE grids are controlled by the inner 2D SWE grids. The upstream and downstream conditions of normal flow, orifice flow, and 1D SWE are also controlled by the outer 2D SWE grids when they are used.

The following breaching process is used in this method/model for a dam failure:
Stage 2—Right after the dam is overtopped either by static reservoir water level or by wind-generated wave, until the dam is fully breached to its bottom, the dam breaching process is in Stage 2. In Stage 2, flow depths and velocities calculated by normal flow, 1D SWE, or 2D SWE are used to do the clear water scouring and force/moment equilibrium analyses. In this stage, 3D slope stability analysis is performed to the breach channel along the main flow direction, local force equilibrium is checked, and instable soil blocks are removed.
Stage 3—After the dam is fully breached to its bottom, the breaching process is in Stage 3. Stage 3 is the lateral widening process. In Stage 3, flow depths and velocities calculated by 2D SWE are used to do the clear water scouring and force/moment equilibrium analyses. In this stage, 3D slope stability analysis is performed to two sides of the breach channel perpendicular to the main flow direction, local force equilibrium is checked, and instable soil blocks are removed.
Stage 4—Right after piping breach starts, until the pipe roof collapses, the dam breaching process is in Stage 4. Either Stage 2 follows Stage 4 if the dam hasn't breached to its bottom when the pipe roof collapses, or Stage 3 follows Stage 4 if the dam has breached to its bottom when the pipe roof collapses. After the pipe roof collapses, the piping breach process becomes the same as overtopping breach in either Stage 2 or Stage 3. Stage 2 follows Stage 4 if the dam hasn't breached to its bottom when the pipe roof collapses. Or Stage 3 follows Stage 4 if the dam has breached to its bottom when the pipe roof collapses. Stage 4 contains three sub-stages:
   (1) Stage 4-1: It uses a piping hole inside of the dam, with inlet-control “just-full” orifice flow in the piping hole.
   (2) Stage 4-2: It uses a rectangular piping path inside of the dam, with inlet-control “just-full” orifice flow in the piping path. This is just one time-step transition between Stage 4-1 and Stage 4-3.
   (3) Stage 4-3: This is the 3D breaching process with the free-surface open channel flow that is used in overtopping breach, and with the pipe roof remaining in place and being eroded laterally. The same breaching method as used in Stage 2 or Stage 3 is used, depending on whether the dam hasn't or has been fully breached through to the dam's bottom, respectively. The pipe roof is eroded laterally and kept until it loses force equilibrium and collapses.

Six points are used to define the phreatic surface in a zoned soil dam. And six points are used to define the phreatic surface in a homogeneous soil dam. The erosion rates to different soils are calculated using different corresponding formulae, including but not limited to the formulae developed by Chen and Anderson (1987a, 1987b) and Clopper and Chen (1988), according to different AASHTO Soil Groups and different construction compaction efforts when the dam was built.

In this model/method, an overtopping failure can start from a pilot channel that is located at the dam's crest and is lower than the dam crest or at the same elevation of the dam crest, as used in IMPACT Field Tests #1 and #2 (Hassan and Morris, 2008); or a dam can be breached by “leading headcut” when it is overtopped everywhere on its crest. “Leading headcut” is defined as the headcut that breaches an earthen dam at a location when the dam is overtopped everywhere along its crest, because that location either has the lowest crest elevation or the largest overtopping depth because of the combination of wave overtopping, or has the worst soil properties, or both, or because of any other unknown reasons and uncertainties.

In this model/method, a piping failure is initiated by pushing a theoretic straight rod from the dam's downstream face into the dam and all the way to the dam's upstream face, and then pulling the rod out immediately.

A wave overtopping failure is modeled in the same way as a normal overtopping breach except the followings:
(1) The fetch, wind setup, and wave runup at every location along the dam are calculated at the beginning according to the dam crest elevation, wind direction and velocity.
(2) Wave overtopping rate is calculated when the reservoir water level is approaching to the dam's crest or the top of pilot channel. If wave overtopping rate is a positive value, the wave overtopping breach starts in the same way as a normal overtopping breach by using an equivalent overtopping depth that results in the same static overtopping rate as the wave overtopping rate.
(3) Once the wave overtopping rate is similar to the normal overtopping rate, wave overtopping is no longer considered, and the exact normal overtopping failure starts.

A liquefaction failure is modeled by removing all soil within the given pilot channel to the dam's bottom immediately when a liquefaction happens at a given high reservoir water level or a time, and then doing the lateral widening in Stage 3 directly.

Multiple breach locations are modeled as a loop starting from the first breach location to the last breach location at each time step. The total breach outflow is the combination of all breach outflows at all breach locations. Each breach location can have either overtopping (or wave overtopping), or piping, or liquefaction failure mode.

### REFERENCES

Chen, Y. H., Anderson, B. A., 1987a. Development of a methodology for estimating embankment damage due to flood overtopping. U.S. Department of Transportation, Federal Highway Administration, Report No. FHWA/RD-86/126. https://ntrl.ntis.gov/NTRL/dashboard/search Results/titleDetail/PB87178356.xhtml.
Chen, Y. H., Anderson, B. A., 1987b. Methodology for estimating embankment damage caused by flood overtopping. Transportation Research Record, 1151.
Clopper, P. E., Chen, Y. H., 1988. Minimizing embankment damage during embankment flow. Final Report No. FHWA/RD-88/181, Simons, Li and Associates, Inc. for Federal Highway Administration and Bureau of Reclamation. Contract No. DTFH61-85-C-00131.
https://www.usbrgovitsc/techreferences/hydraulics_lab/pubs/PAP/PAP-0607.pdf.
Fread, D. L., 1984. DAMBRK: The NWS dam-break flood forecasting model, Hydrologic Research Laboratory, National Weather Service, Silver Spring, Maryland, USA.
Fread D. L., 1988. BREACH: An erosion model for earthen dam failures. National Weather Service, Office of Hydrology, Silver Spring, Maryland, USA.
Fread, D. L, Lewis, J. M, 1998. NWS FLDWAV model, National Weather Service, NOAA, Silver Spring, Maryland, USA.
Gray, R. E., 1992. Chapter 13—Failure of Laurel Run Dam. In Geomechanics and Water Engineering in Environmental Management (book), Editor: Robin Chowdhury.
Hassan, M. A. A. M., Morris, M. W., 2008. IMPACT Project field tests data analysis. FLOODsite Report T04-08-04. UK. Website: https://www.floodsite.net/html/partner_area/project_docs/T04_08_04_IMPACT_Data_Analysis_v3_3.pdf
Phatak, D. R., Pathak, S. R., Birid, K. C., 2004. Estimation of phreatic line using dimensional analysis. In Fifth International Conference on Case Histories in Geotechnical Engineering, New York, USA, Apr. 13-17, 2004.
Temple, D. M. (1992). Estimating flood damage to vegetated deep soil spillways. Applied Engineering in Agriculture, 8(2), 237-242.
Wang, Z., Bowles, D. S., 2006a. Three-dimensional non-cohesive earthen dam breach model. Part 1, theory and methodology. Advances in Water Resources. Vol. 29 (10): 1528-1545.
Wang, Z., Bowles, D. S., 2006b. Three-dimensional non-cohesive earthen dam breach model. Part 2, validation and applications. Advances in Water Resources. Vol. 29 (10): 1490-1503.
Wang, Z., Bowles, D. S., 2006c. Dam breach simulations with multiple breach locations under wind and wave Actions. Advances in Water Resources. Vol. 29 (8): 1222-1237.
Wu, W., 2013. Simplified physically-based model of earthen embankment breaching. Journal of Hydraulic Engineering, ASCE, 139(8), 837-851.

1. A numerical method of calculating the dam breach hydrograph along with the removed soil graph, and a corresponding computer program/model executing on a computer running on Microsoft Windows, wherein the dam can be a homogeneous cohesive soil dam, a homogenous non-cohesive soil dam, or a zoned soil dam with a cohesive soil core and shells that can be either non-cohesive soil or another cohesive soil with a less cohesion and/or a smaller plasticity index than the cohesive soil of the core; wherein 3D cuboids with one group of soil, extending vertically from a dam's bottom to the dam's surface, are used to model homogeneous cohesive or non-cohesive soil dams, to model the shell soil of a zoned soil dam, and to model any portion of a dam that contains only one soil from bottom of dam vertically to surface of dam; wherein 3D cuboids with two groups of soil, with one soil on top and another soil on bottom of a cuboid, extending vertically from a dam's bottom to the dam's surface, are used to model a zoned soil dam's clay core portion; wherein the erosion rates to soils are calculated using different formulae according to different AASHTO Soil Groups and different construction compaction efforts when the dam was built; wherein the headcut migration stage and lateral widening stage are used for a homogeneous cohesive soil dam, a homogeneous non-cohesive soil dam, and a zoned soil dam; wherein 3D slope stability analysis is performed to the breach channel during the headcut migration stage along the main flow direction in the breach channel, before the dam is breached through to its bottom; wherein 3D slope stability analysis is performed to two sides of the breach channel during the lateral widening stage perpendicular to the main flow direction in the breach channel, after the dam has been breached through to its bottom; wherein local force equilibrium is checked in the entire dam-breaching process and instable soil blocks are removed; wherein six points are used to define the phreatic surface in a zoned soil dam; wherein six points are used to define the phreatic surface in a homogeneous soil dam; wherein a dam can be breached by overtopping flow, by wind-generated wave overtopping, by piping flow (internal erosion), or by statistic liquefaction; wherein the number of breaching locations can be one or more than one, and the failure modes can anyone or combination among overtopping failure, piping failure, and liquefaction failure, or anyone or combination among wave overtopping failure, piping failure, and liquefaction failure; wherein in the overtopped failure mode, a dam can be breached by overtopping flow through a pilot channel on the dam crest, or can be breached by overtopping flow through “leading headcut” when the dam is overtopped everywhere along its crest; wherein “leading headcut” is defined as the headcut that breaches an earthen dam at a location when the dam is overtopped everywhere along its crest, because that location either has the lowest crest elevation or the largest overtopping depth because of the combination of wave overtopping, or has the worst soil properties, or both, or because of any other unknown reasons and uncertainties; wherein the topographic information surrounding the dam is represented by the outer two-dimensional (2D) Shallow Water Equations (SWE) domain that controls the boundary conditions, such as the upstream inflow condition and the downstream outflow condition; wherein a smaller layer of inner 2D SWE grids is generated automatically by this model to cover the dam's breached portion and the breach channel area; wherein the outer 2D SWE grids and the inner 2D SWE grids exchange data at each time-step calculation, so that the inner 2D SWE grids' boundary conditions are controlled by the outer 2D SWE grids and the outer 2D SWE grids' data inside of the inner 2D SWE grids are controlled by the inner 2D SWE grids; wherein the upstream and downstream conditions of normal flow, orifice flow, and 1D SWE are also controlled by the outer 2D SWE grids when they are used; and wherein elevations of a dam's crest and bottom and soil properties at different stations along the dam's centerline are modeled.

2. A visualization method of showing a dam and the topographic information surrounding the dam within the domain of the outer 2D SWE, the dam breaching process, flow's depths and velocities, and the rising and receding of reservoir water level during dam breaching process, and a corresponding computer program/model executing on a computer running on Microsoft Windows, wherein the dam and the topographic information surrounding the dam within the domain of the outer 2D SWE, the dam breaching process, the flow depths, and the flow velocity vectors are shown, moved, and rotated on the computer's screen using the revised Microsoft Visual C++ code of CGLEnabledView (version 1.4) posted on www.codeproject.com, originally developed by Alessandro Falappa who has granted users the right to use, copy, and modify the original code; and wherein the rising and receding of water level in the reservoir is shown on the computer's screen through a DEM that contains the dam and its reservoir.

3. A computer-implemented method of generating and preparing input data from USGS DEM, and a corresponding computer program/model executing on a computer running on Microsoft Windows, wherein the downloaded USGS DEM in decimal degree format (coordinate with latitude and longitude), after being cut into a small area containing the dam, its reservoir, and the surrounding area, is projected to corresponding UTM zone in meters (with easting and northing), and then is rotated so that the dam is shown horizontally at a computer screen and its reservoir is shown at the dam's top by using the coordinates (latitude and longitude) of the left end and the right end of the dam, or by using the eastings and northings of the left end and the right end of the dam; wherein the dam can be displayed horizontally at a computer screen and its reservoir is shown at the dam's top, or the dam can be displayed with an angle between 0 and 360 degrees given by the user, by using 0 (or 360) degree when the dam is displayed horizontally at a computer screen and its reservoir is shown at the dam's top; wherein the location of the dam, as defined as a line by its left end and right end, is given within the rotated DEM, thereby the dam's centerline can be easily found in the domain of the outer 2D SWE grids; and wherein the reservoir's stage—surface area curve is calculated from the projected DEM, with an adjustment in elevations if the dam's vertical datum is different from the downloaded USGS DEM's vertical datum.
